(19) United States
(12) Patent Application Publication
(10) Pub. No.: US 2018/0352042 A1
(43) Pub. Date: Dec. 6, 2018

(54) Providing Device Information to Third Party Without Identifying the Device

(71) Applicant: Apple Inc., Cupertino, CA (US)

(72) Inventors: Erik C. Neuenschwander, San Mateo, CA (US); Hamid M. Osman, Coquitlam (CA); Solomon Reda, San Francisco, CA (US); Dmytro V. Bilov, Santa Clara, CA (US); James C. Wilson, San Jose, CA (US); Eric Daniel Friedman, Berkeley, CA (US); Thomas P. Mensch, Sunnyvale, CA (US); Alan W. Yu, Vancouver (CA)

(21) Appl. No.: 15/721,541

(22) Filed: Sep. 29, 2017

Related U.S. Application Data
(60) Provisional application No. 62/514,867, filed on Jun. 4, 2017.

(51) Int. Cl. H04L 29/08; H04L 9/30; G06Q 20/38; H04L 9/32

(52) U.S. Cl. CPC H04L 67/20; H04L 9/30; H04L 9/3297; H04L 9/321; G06Q 20/38215

(57) ABSTRACT

Some embodiments provide a method of providing information to a third-party service. From the third-party service, the method receives a request for information regarding a particular device that is transacting with the third-party service. The request includes data encrypted by the particular device that is inaccessible to the third-party service. The method accesses the encrypted data to determine a unique identifier of the particular device. The method uses the unique identifier to determine the requested information. The method provides the requested information to the third-party service without providing an identity of the device to the third-party service.

### BACKGROUND

Third-party services (e.g., food-delivery services, various types of content subscription services, etc.) can often benefit from finding out information about a device that is attempting to sign up with the service or initiate a new transaction (e.g., whether the device has previously signed up with a different account to take advantage of an offer to new users). However, for privacy purposes, users (and device manufacturers) may not want the third-party services to be able to track a device through time, or be able to collude with other third-party services to find out additional information about a device and/or its user.

### BRIEF SUMMARY

Some embodiments provide a method for providing information about a device to a third-party service that is transacting with the device, without providing device-identifying information to the third-party service. The method of some embodiments receives a request for the information from the third-party service, with the request including data encrypted by the device in such a way as to be inaccessible to the third-party service. The method accesses this encrypted data in order to determine an identify of the device, and uses this device identity to access the requested information and provide this information to the third-party service.

In some embodiments, the method is performed by a set of servers operated by a manufacturer of the device or other operator with which the device is registered and which stores device-identifying information (e.g., a device identifier). The third-party service may be a service that develops and offers one or more applications that can be installed on devices (e.g., smartphones, tables, other mobile devices, laptop or desktop computers, etc.), such as a content provider service (e.g., video or audio streaming services, article subscription services, etc.), a product delivery service (e.g., food delivery, etc.), a ride-sourcing service, etc. In some situations, it may be useful to the third-party service to know various facts about the device that is being used to sign up, in case a user of the device has previously signed up for the service with the device, then uninstalled the application and erased its data in order to sign up again as a new user. For instance, a user might want to take advantage of an offer for first-time users (e.g., a free 30-day trial, a discount, etc.) more than once. In addition, it would be useful to the third-party service to know if the device was previously used to commit or attempt fraud (e.g., using a stolen credit card number).

Thus, in some embodiments, the set of servers store data about the device that indicates at least one of (i) whether the device has performed a similar transaction with the third-party service and (ii) whether the device has been used for a fraudulent transaction with the third-party service (or, in some embodiments, any third-party service). The third-party service notifies the set of servers when a device performs the transaction (e.g., signing up for a free trial), and the set of servers stores this information mapped to the device identifier. For storing this information with the set of servers, the third-party service only has an identifier that can be changed by a user, but which the set of servers can map to the device identifier.

In some embodiments, the information is stored by the set of servers as two single-bit pieces of data for a device-application (or device-service) pairing. For example, the set of servers might store a 0 indicating that the device has never signed up for a particular service, and switch this value to a 1 once the service has notified the set of servers that the device has signed up. Similarly, the set of servers stores a 0 indicating that the device has never been used for or attempted a fraudulent transaction with the particular service, then switch this value to a 1 once the service notifies the set of servers regarding such a fraudulent transaction. In addition, some embodiments store an inexact timestamp (e.g., only a month/year) for the sign-up indication. In some cases, the device might be given to a different person (e.g., a friend or family member), sold, refurbished, etc., and a new user of the device would want to sign up for a third-party service that a previous user had already used. In this case, the third-party service can use the timestamp information to make a business decision on whether to allow the new user to take advantage of a new-user offer.

As mentioned, with the request for the information about a device, the set of servers receives data encrypted by the device that can be used to identify the device. In some embodiments, this encrypted data includes a certificate (e.g., an X509 certificate) that stores the device identifier. The certificate is provided by an authority (e.g., a different set of servers managed by the device manufacturer or registration service) in response to a separate transaction directly between the device and that authority. In some embodiments, the device uses a device-specific key that is known to the certificate authority (or that is based on a device-specific piece of data known to the certificate authority) in order to acquire the certificate.

To encrypt the certificate such that (i) only the set of servers can decrypt the certificate and (ii) only the device could have encrypted the certificate, the device of some embodiments generates a shared secret (e.g., using an Elliptic Curve Diffie-Hellman (ECDH) process). The set of servers has its own (long-term, in some embodiments) public-private key pair, and the device generates a single-transaction key pair in some embodiments. The device uses the public key of the set of servers and the private key of its single-transaction key pair to generate the shared secret, and uses this shared secret to generate a key for encrypting the certificate. It then includes the public key of the single-transaction key pair unencrypted along with the certificate (but also attested to by the certificate authority via the certificate).

In order to decrypt the certificate, the set of servers uses its own private key and the public key of the single-transaction key pair (received unencrypted with the certificate) to generate a corresponding shared secret and corresponding decryption key. The set of servers decrypts the certificate and extracts the device identifier, which it uses to retrieve the requested information (e.g., from its database or other storage). The set of servers then provides this information to the third-party service.

In addition, prior to providing the data to the third-party service, in some embodiments the set of servers validates that the third-party service is authorized to make the request for the specific application. Specifically, in some embodiments, the third-party service sends a token along with the encrypted certificate and unencrypted public key from the device. This token identifies the application/service developer from which the request is received. In some embodiments, the encrypted data from the device also includes an application identifier (because this identifier is encrypted, the third-party service cannot inspect or modify it). The set of servers uses the token to retrieve (e.g., from a different set of servers operated by the device manufacturer or registration service) a developer identifier and a set of application identifiers associated with the developer identifier (a developer might have multiple applications). Some embodiments only provide the requested information about the device if the encrypted application identifier from the device matches one of the application identifiers associated with the developer identifier from the third-party service request.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description further describe the embodiments described in the Summary as well as other embodiments. Accordingly, to understand all the embodiments described by this document, a full review of the Summary, the Detailed Description, and the Drawings is needed. Moreover, the claimed subject matters are not to be limited by the illustrative details in the Summary, the Detailed Description, and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purposes of explanation, several embodiments of the invention are set forth in the following figures.

FIG. 1 conceptually illustrates a system of some embodiments including a set of device information servers, a third-party service, a device, and a certificate authority.

FIG. 2 conceptually illustrates the architecture of a device of some embodiments.

FIG. 3 conceptually illustrates a process of some embodiments for generating encrypted data for a third-party application, so that a corresponding third-party service can use the encrypted data to request information about a device.

FIG. 4 conceptually illustrates the device information servers of some embodiments, with which a third-party service communicates to receive device information.

FIG. 5 conceptually illustrates a process for verifying and responding to a device information request from a third-party service.

FIG. 6 illustrates an example of an architecture of a mobile computing device with which some embodiments are implemented.

FIG. 7 conceptually illustrates another example of an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method for providing information about a device to a third-party service that is transacting with the device, without providing device-identifying information to the third-party service. The method of some embodiments receives a request for the information from the third-party service, with the request including data encrypted by the device in such a way as to be inaccessible to the third-party service. The method accesses this encrypted data in order to determine an identify of the device, and uses this device identity to access the requested information and provide this information to the third-party service.

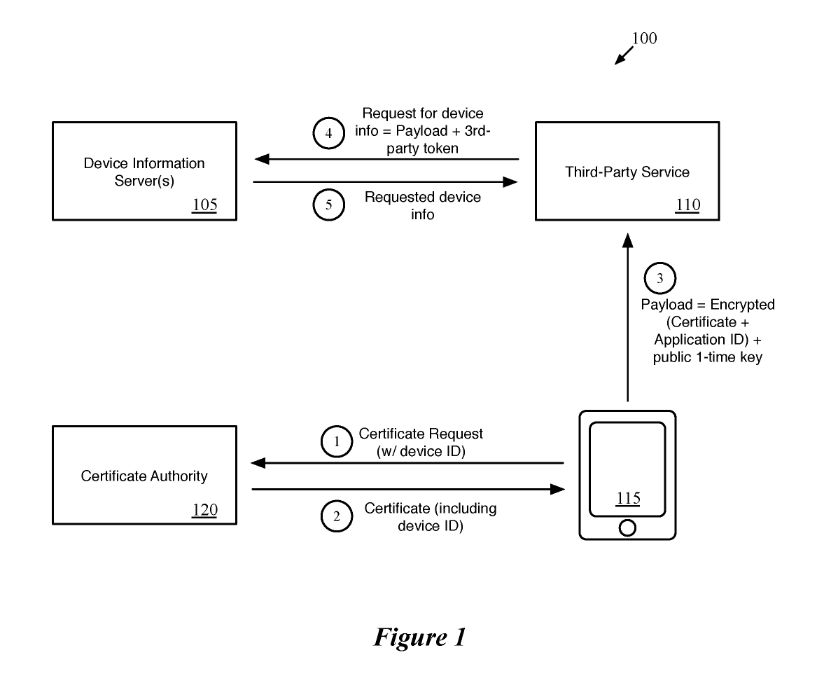

In some embodiments, the method is performed by a set of servers operated by a manufacturer of the device or other operator with which the device is registered and which stores device-identifying information (e.g., a device identifier). FIG. 1 conceptually illustrates a system 100 of some embodiments including such a set of device information servers 105, a third-party service 110, a device 115, and a certificate authority 120.

The third-party service 110 may be a service that develops and offers one or more applications that can be installed on the device 115 (which may be, e.g., a smartphone, tablet, other mobile device, laptop computer, desktop computer, etc.). Examples of such third-party services 110 include a content provider service (e.g., video or audio streaming services, article subscription services, etc.), a product delivery service (e.g., food delivery, etc.), a ride-sourcing service, etc. In some situations, it may be useful to the third-party service 110 to know various facts about the device 115 that is being used to sign up with the service, in case a user of the device 115 has previously signed up for the service with the same device, then uninstalled the application offered by the service and erased its data in order to sign up again as a new user. For instance, a user might want to take advantage of an offer for first-time users (e.g., a free 30-day trial, a discount, etc.) more than once. In addition, it would be useful to the third-party service 110 to know if the device 115 was previously used to commit or attempt fraud (e.g., using a stolen credit card number).

Thus, in some embodiments, the device information servers 105 store data about the device 115 (and numerous other devices) that indicates at least one of (i) whether the device 115 has performed a similar transaction with the third-party service 110 and (ii) whether the device has been used for a fraudulent transaction with the third-party service 110 (or, in some embodiments, any third-party service). The third-party service 110 notifies the device information servers 105 when a device performs the transaction (e.g., signing up for a free trial), and the device information servers store this information mapped to the device identifier. For storing this information with the device information servers 105, the third-party service 110 only has an identifier that can be changed by a user (i.e., so that it cannot be used to track the user if the user chooses to not be tracked), but which the device information servers can map to the device identifier.

In some embodiments, the information is stored by the device information servers 105 as two single-bit pieces of data for a device-application (or device-service) pairing. For example, the device information servers 105 might store a 0 indicating that the device 115 has never signed up for a particular service 110, and switch this value to a 1 once the service 110 has notified the device information servers 105 that the device 115 has signed up. Similarly, the device information servers 105 stores a 0 indicating that the device 115 has never been used for or attempted a fraudulent transaction with the particular service 110, then switch this value to a 1 once the service 110 notifies the device information servers 105 regarding such a fraudulent transaction. In addition, some embodiments store an inexact timestamp (e.g., only a month/year) for the sign-up indication and/or the fraudulent transaction indication. In some cases, the device 115 might be given to a different person (e.g., a friend or family member), sold, refurbished, etc., and a new user of the device would want to sign up for a third-party service 110 that a previous user of the device 110 had already used. In this case, the third-party service 110 can use the timestamp information to make a business decision on whether to allow the new user to take advantage of a new-user offer.

As shown in the figure, prior to sending the previously-mentioned encrypted data to the third-party service 110, the device 115 acquires a certificate (e.g., an X509 certificate) from a certificate authority 120. In some embodiments, the certificate the device 115 receives from the certificate authority 120 includes a device identifier (e.g., a unique device identifier, or UDID), which the device information servers 105 eventually use to identify the device about which the third-party service 110 is requesting information. The certificate authority, in some embodiments, comprises a set of servers also managed by the device manufacturer or registration service (i.e., the same operator as the device information servers 105). In some embodiments, the device 115 uses a device-specific key that is known to the certificate authority (or that is based on a device-specific piece of data known to the certificate authority) in order to acquire the certificate. As shown, the device 115 sends a certificate request (identified by the encircled 1) to the certificate authority 120. This certificate request identifies the device by its identifier (e.g., the UDID). In addition, the certificate request of some embodiments is encrypted with or otherwise proves possession of a device-specific key or seed data that is stored in a secure memory of the device 115. Assuming the request is proper, the certificate authority 120 returns a certificate (identified by the encircled 2) to the device 115. This certificate, in addition to attesting to the validity of the device-specific key, also includes the device identifier, thereby ensuring that the device identifier can be trusted when received by the device information servers 105.

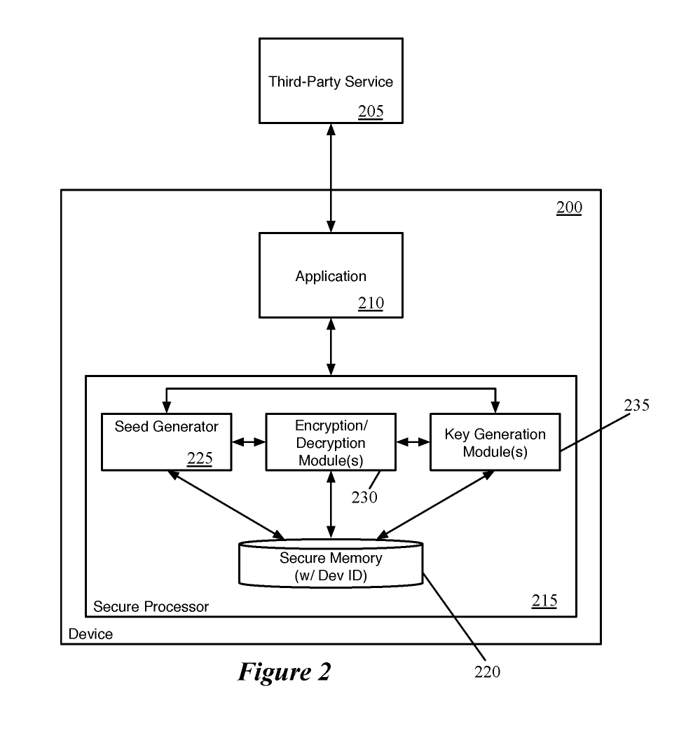

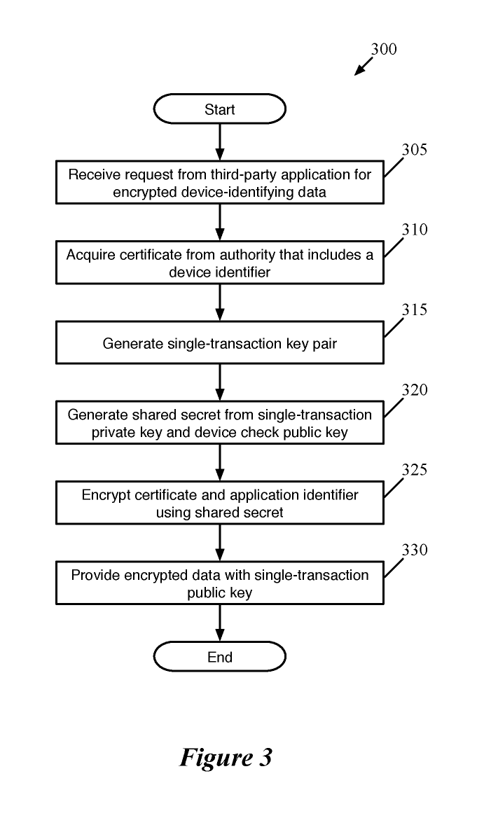

The device 115 sends to the third-party service 110 a set of encrypted data (also referred to as an encrypted payload) along with a single-transaction public key, as shown by the encircled 3. To encrypt the certificate such that (i) only the device information servers 105 can decrypt the certificate and (ii) only the device could have encrypted the certificate, the device of some embodiments generates a shared secret (e.g., using an Elliptic Curve Diffie-Hellman (ECDH) process). The device information servers 105 have their own (long-term, in some embodiments) public-private key pair, and the device generates a single-transaction key pair in some embodiments. The device 115 uses the public key of the device information servers and the private key of its single-transaction key pair to generate the shared secret, and uses this shared secret to generate a key for encrypting the certificate. The device 115 then includes the public key of the single-transaction key pair unencrypted along with the certificate (but also attested to by the certificate authority via the certificate). The operation of the device 115 of some embodiments will be described in further detail below by reference to FIGS. 2 and 3.

The third-party service 110 passes this encrypted payload onto the device information servers 105 with its request for information about the device 115. In addition, as shown by the encircled 4, the request also includes a third-party service token, which the device information servers 105 use to verify that the third-party service 110 is requesting information for an application with which it is associated.

In order to decrypt the payload, the device information servers 105 use their own private key and the public key of the single-transaction key pair (received unencrypted with the certificate) to generate a corresponding shared secret and corresponding decryption key. The device information servers decrypt the certificate and extracts the device identifier, which it uses to retrieve the requested information (e.g., from its database or other storage). The device information servers 105 then provide this information to the third-party service 110, as shown by the encircled 5.

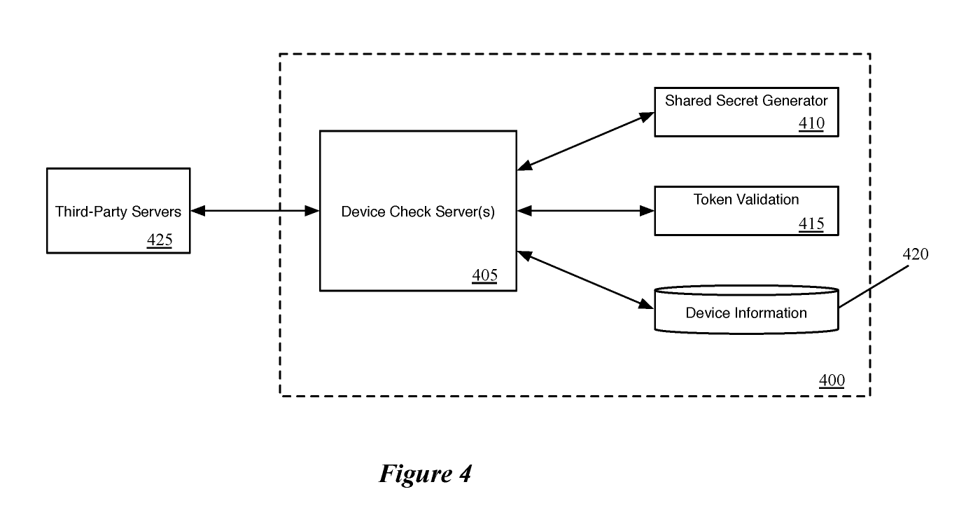

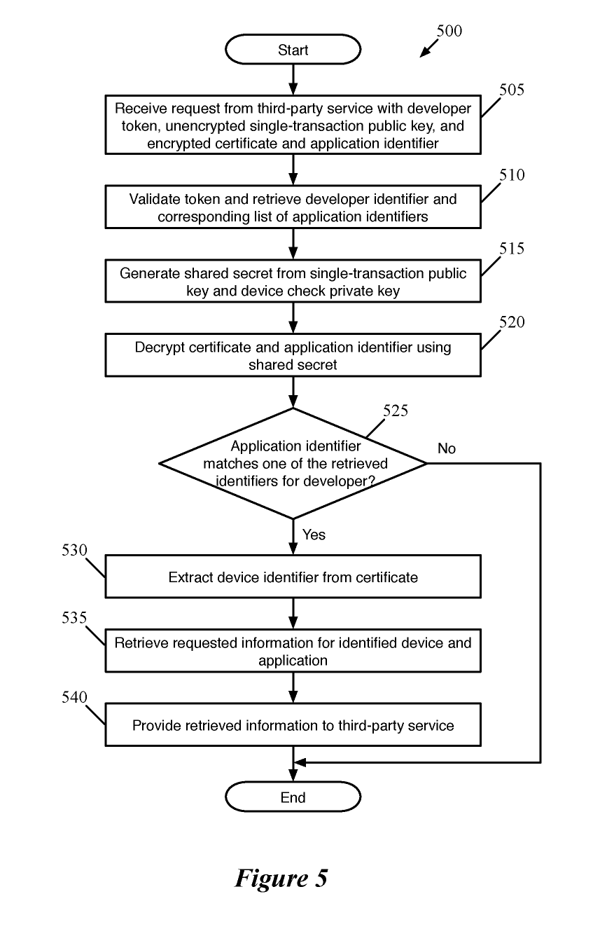

In addition, prior to providing any data to the third-party service, in some embodiments the device information servers 105 validate that the third-party service 110 is authorized to make the request for the specific application. The token sent along with the request identifies the application/service developer from which the request is received (i.e., the developer of the third-party service 110 and the corresponding application on the device 115). In some embodiments, the encrypted payload from the device also includes an application identifier (because this identifier is encrypted, the third-party service cannot inspect or modify it). The device information servers use the token to retrieve (e.g., from a different set of servers operated by the device manufacturer or registration service) a developer identifier and a set of application identifiers associated with the developer identifier (a developer might have multiple applications). Some embodiments only provide the requested information about the device if the encrypted application identifier from the device matches one of the application identifiers associated with the developer identifier from the third-party service request. The operation of the device information server(s) 105 will be described in further detail below by reference to FIGS. 4 and 5.

FIG. 2 conceptually illustrates the architecture of a device 200 of some embodiments (e.g., the device 115). This device 200 may be a personal electronic device on which various third-party applications operate on top of an operating system, in some embodiments (e.g., a smart phone, tablet, other mobile device, laptop computer, desktop computer, etc.). As shown, the device transacts with a third-party service 205 (i.e., with servers of such as service). The device includes at least one application 210 that is associated with the third-party service 205.

In addition, the device includes a secure processor 215 (also referred to as a secure enclave processor). The secure processor 215 of some embodiments includes modules for various cryptographic processes, as well as a secure memory 220. The secure memory 220 stores a unique device identifier (e.g., a UDID) in some embodiments. As shown, the cryptographic modules of some embodiments include a seed generator 225, an encryption and decryption module 230 (e.g., for performing AES or another encryption and decryption technique), and a key generation module 235. It should be understood that these are examples of cryptographic modules that can execute in the secure processor 215, and various different embodiments may include various different modules (e.g., modules for digitally signing data, etc.).

The operation of the device 200 will be described by reference to FIG. 3, which conceptually illustrates a process of some embodiments for generating encrypted data for a third-party application, so that a corresponding third-party service can use the encrypted data to request information about the device. As shown, the process 300 begins by receiving (at 305) a request from a third-party application for encrypted device-identifying data. In some embodiments, the third-party application makes an application programming interface (API) call to an operating system framework to request the encrypted data.

The request, in some embodiments, includes an application identifier that is known to the device information servers. In some embodiments, the third-party service is registered with the device and/or operating system manufacturer. The device and/or operating system manufacturer, in some embodiments, provides an environment in which third-party services develop applications and register the service and associated applications with the manufacturer. Examples of such third-party services with corresponding application(s) on a device include content provider services (e.g., video or audio streaming services, article subscription services, etc.), product delivery services (e.g., food delivery, etc.), ride-sourcing services, etc.

The devices are registered with the manufacturer, which enables the manufacturer to provide information (via the device information servers) about the devices to the third-party service. In addition, via the application identifier sent from the device, the device information servers can verify that the third-party service is making an appropriate request.

The process 300 acquires (at 310) a certificate (e.g., an X509 certificate), that includes a unique device identifier, from a certificate authority. In some embodiments, the certificate authority is also operated by the device and/or operating system manufacturer. Though shown as occurring after (e.g., in response to) the request from the third-party application, in some embodiments, if the device has recently received such a certificate (e.g., for a similar request from a different application, or for a completely separate process), this existing certificate is used. For instance, in some embodiments the certificate is considered valid for a predefined period of time after it is issued by the certificate authority (e.g., 24 hours, 72 hours, etc.).

In some embodiments, the certificate the device receives from the certificate authority includes a device identifier (e.g., the UDID stored in the secure memory 220). In some embodiments, various modules executing on the secure processor are used in order to generate the certificate request (for instance, some embodiments generate a seed, and from this seed a device-specific key to which the certificate attests). The device sends this data, along with its device identifier, to the certificate authority (encrypted, in some embodiments). Assuming the request is proper, the certificate authority returns a certificate to the device 200. This certificate, in addition to attesting to the validity of the device-specific key, also includes the device identifier, thereby ensuring that the device identifier can be trusted when received by the device information servers. Because the certificate is signed digitally, the device identifier cannot be modified before being encrypted by the device. Some embodiments do not use the key to which the certificate attests for the request from the application, instead using the certificate as a trusted source of the device identifier.

The process 300 next generates (at 315) a single-transaction key pair. Some embodiments generate a completely random key pair by first randomly generating a seed value (e.g., with the seed generator 225), then generating private and public keys using the key generation module 225 (which utilizes, e.g., a key derivation function). In some embodiments, the seed is based on a device-specific identifier. The single-transaction key pair generated by the device is used only for the specific transaction of encrypting the certificate (and application identifier) such that the third-party will not be able to access this data. This ensures that even if the same certificate is used for multiple similar requests, the encrypted data will always appear different and thus the encrypted data is not trackable from one request to another.

Next, the process generates (at 320) a shared secret from the single-transaction private key and the device information server public key. In different embodiments, the device learns this public key either via the servers publishing the key or via the public key being pre-installed on the device. In some embodiments, this is a long-term key that only changes if there is concern that the device information server private key has been compromised. In that case, different embodiments will publish a new public key differently. In other embodiments, this public key changes regularly or even with each transaction, and the device is required to acquire the public key from the servers before generating the shared secret. In order to generate the shared secret, some embodiments use an ECDH process. In this process, the device uses its private key and the server public key to generate a shared secret value, while the server uses its private key and the device public key to generate either the same or a corresponding secret value. This secret value either is used as a shared key or a seed from which the shared key is derived.

As such, the process next encrypts (at 325) the certificate and application identifier using the shared secret. In some embodiments, the certificate and application identifier are encrypted as a single data blob from which both data items can be extracted once the data blob is decrypted. In some embodiments, the encryption/decryption module(s) 230 use an authenticated encryption, such as Galois/Counter Mode (GCM) AES. This ensures that, after decryption, the device information servers can verify that the payload has not been tampered with (e.g., to change the application identifier).

With the data encrypted, the process provides (at 330) the encrypted data with the single-transaction public key (in unencrypted format) to the application (e.g., application 210). The single-transaction public key is not encrypted because having only the public key does not provide access to the encrypted data without the device information servers private key, and because the device information servers need the single-transaction public key in order to decrypt the data. The application 210 communicates with the third-party service 205, sending the encrypted data and single-transaction public key to the service 205.

As described above, the third-party service 205 is not able to decrypt or track the data received from the device 200. The public key is a random single-use key, and thus does not provide any device-identifying information. In addition, not only is the third-party service unable to decrypt the data blob, it cannot track encrypted data blobs, as these change each time on account of the use of a one-time key. Instead, the third-party service uses the data as received in a request sent to the device information servers.

FIG. 4 conceptually illustrates the device information servers 400 of some embodiments, with which a third-party service (actually, many third-party services) 425 communicates to receive device information. These servers 400 include a device check server (or servers) 405, a shared secret generator 410, a token validator 415, and a device information storage 420. In different embodiments, these various servers or modules may operate on a single physical device or separate physical devices, may operate in one or more clusters (e.g., a cluster of device check servers, a cluster of token validators, etc.). When operating on the same physical device, in different embodiments the various servers may operate as separate applications or modules on a single operating system, or may operate in separate virtual machines on the same physical device. In some embodiments, all of the device information servers 400 are managed by the same organization (e.g., the device manufacturer, operating system developer/manufacturer, device registration service, etc.) that securely stores the device information.

The operation of the device information servers 400 for handling requests from the third-party service 425 for information about a device will be described by reference to FIG. 5. FIG. 5 conceptually illustrates a process 500 for verifying and responding to a device information request from a third-party service (e.g., the third-party service 425). In some embodiments, this process 500 is performed by a device-check server 405, which uses the shared secret generator 410, token validator 415, and device information storage 420 to perform various cryptographic, validation, and information retrieval operations.

As shown, the process 500 begins by receiving (at 505) a request from a third-party service. The request, in some embodiments, includes a developer token, an unencrypted single-transaction public key generated by the device about which information is requested, and an encrypted certificate and application identifier. In some embodiments, the encrypted certificate and application identifier is a single encrypted data blob. As described above, the encrypted data and single-transaction public key are generated by the device in a transaction with the third-party service 425, and the third-party service passes this data onto the device check server 405 (which serves as an interface with the third-party services). The third-party service additionally provides its developer token, which is used to verify that the third-party service is in fact affiliated with the application for which it is asking for information. In some embodiments, this developer token is a Java web token.

The process 500 then validates (at 510) the token and retrieves (i) a developer identifier and (ii) a corresponding list of application identifiers for the third-party service. In some embodiments, the device check server 405 sends the developer token to the token validator 415 which authenticates the developer and returns the developer and application identifiers. In some embodiments, a single developer might have multiple applications that can operate on a device and are registered with the device or operating system manufacturer. For instance, a sports media company might have a video streaming application, a fantasy sports application, etc. As another example, a ride-sourcing service might have separate applications for ride-sourcing and for food delivery, which would be associated with different application identifiers but the same developer identifier.

Next, the process 500 generates (at 515) a shared secret from the single-transaction public key and its own private key. The single-transaction public key, as described, is received unencrypted with the request, thereby enabling the generation of the shared secret without the need to decrypt any data beforehand (but only for the device check server which possesses the required private key. As mentioned for the device, in some embodiments this process is an ECDH shared secret generation. In some embodiments, a separate shared secret generator 410 (that is part of the device information servers managed by the device or operating system manufacturer or registration service) is used to generate this shared secret. The shared secret generator 410, which holds the private key, is therefore not exposed to the public (i.e., to the third-party services). In other embodiments, this functionality is part of the device check server 405 itself.

With the shared secret, the process 500 decrypts (at 520) the certificate and application identifier received with the request. As mentioned above, in some embodiments the device uses an authenticated encryption (e.g., GCM AES), and thus in addition to decrypting the data the device check server is ensured that the data is accurate and has not been modified somehow by the third-party service or an intermediary attacker.

Next, the process 500 determines (at 525) whether the application identifier from the decrypted data blob (i.e., the application identifier received from the device) matches one of the application identifiers retrieved based on the developer token. When the received application identifier does not match with the third-party service developer, the request is invalid, and the process ends. Some embodiments provide an error message or warning to the third-party service.

On the other hand, when the received application identifier matches one of the applications associated with the third-party service, the process 500 continues, and extracts (at 530) the device identifier from the decrypted certificate. As described above, the certificate authority includes the device identifier (e.g., the UDID) in the certificate when it generates the certificate, which makes the certificate useful for the device information request.

With the device identifier, the process 500 retrieves (at 535) the requested information for the identified device and application, and provides (at 540) this information to the third-party service. The process 500 then ends. In some embodiments, this information is stored in a database or other storage (e.g., the device information storage 430). The information stored in some embodiments maps the device identifier (which is a hardware identifier that remains unchanged even if the device is erased) to data indicating whether (i) the device has performed a similar transaction with the third-party service and (ii) the device has been used for a fraudulent transaction with the third-party service (or, in some embodiments, any third-party service).

In some embodiments, the information is stored as two single-bit pieces of data for a device-application (or device-service) pairing. For example, the device information storage 420 might store a 0 indicating that the device has never signed up for a particular service, and switch this value to a 1 once the service has notified the device check servers 405 that the device has signed up. Similarly, the device information storage 420 stores a 0 indicating that the device has never been used for or attempted a fraudulent transaction with the particular third-party service, then switches this value to a 1 once the service 425 notifies the device check servers 405 regarding such a fraudulent transaction or attempt. In addition, some embodiments store an inexact timestamp (e.g., only a month/year) for the sign-up indicator and/or fraudulent transaction indicator. In some cases, the device might be given to a different person (e.g., a friend or family member), sold, refurbished, etc., and a new user of the device would want to sign up for a third-party service for which a previous user of the device already had an account. In this case, the third-party service 425 can use the timestamp information to make a business decision on whether to allow the new user to take advantage of a new-user offer.

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs.

Finally, any combination of separate programs that together implement a software invention described here is within the scope of the invention. In some embodiments, the software programs, when installed to operate on one or more electronic systems, define one or more specific machine implementations that execute and perform the operations of the software programs.

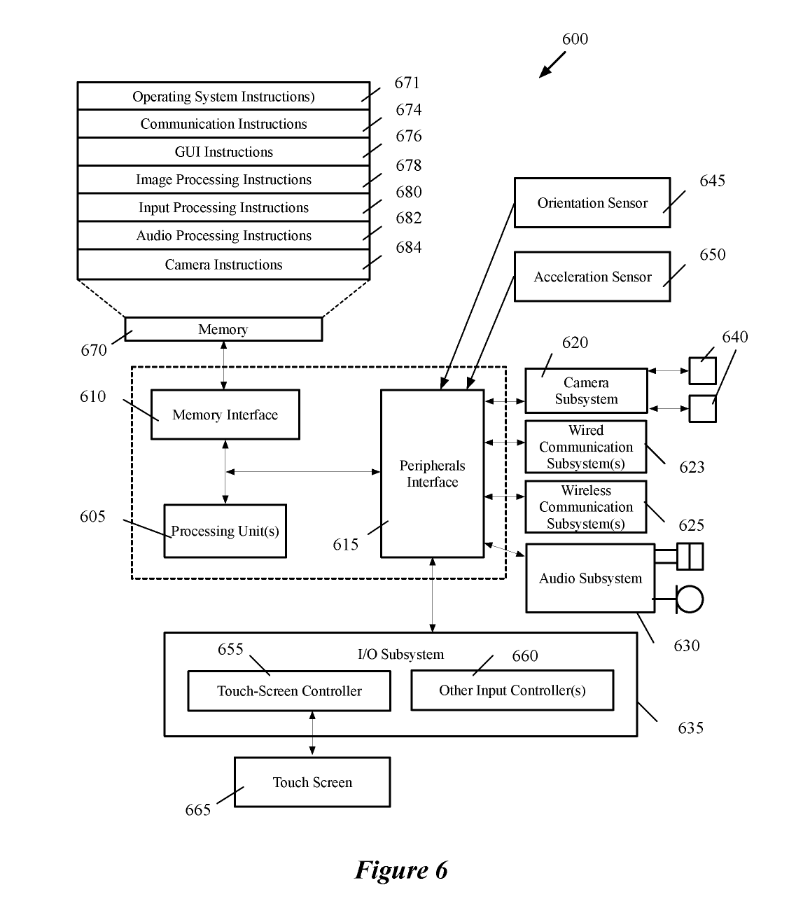

The third-party applications and encryption processes of some embodiments operate on mobile devices, such as smart phones (e.g., iPhones®) and tablets (e.g., iPads®). FIG. 6 is an example of an architecture 600 of such a mobile computing device. As shown, the mobile computing device 600 includes one or more processing units 605 (e.g., a central processing unit CPU or set of CPU cores, a secure enclave processing unit, a graphics processing unit, etc.), a memory interface 610 and a peripherals interface 615.

The peripherals interface 615 is coupled to various sensors and subsystems, including a camera subsystem 620, a wired communication subsystem(s) 623, a wireless communication subsystem(s) 625, an audio subsystem 630, an I/O subsystem 635, etc. The peripherals interface 615 enables communication between the processing units 605 and various peripherals. For example, an orientation sensor 645 (e.g., a gyroscope) and an acceleration sensor 650 (e.g., an accelerometer) is coupled to the peripherals interface 615 to facilitate orientation and acceleration functions.

The camera subsystem 620 is coupled to one or more optical sensors 640 (e.g., a charged coupled device (CCD) optical sensor, a complementary metal-oxide-semiconductor (CMOS) optical sensor, etc.). The camera subsystem 620 coupled with the optical sensors 640 facilitates camera functions, such as image and/or video data capturing. The wired communication subsystem 623 and wireless communication subsystem 625 serve to facilitate communication functions.

In some embodiments, the wireless communication subsystem 625 includes radio frequency receivers and transmitters, and optical receivers and transmitters (not shown in FIG. 6). These receivers and transmitters of some embodiments are implemented to operate over one or more communication networks such as a GSM network, a Wi-Fi network, a Bluetooth network, etc. The audio subsystem 630 is coupled to a speaker to output audio (e.g., to output voice navigation instructions). Additionally, the audio subsystem 630 is coupled to a microphone to facilitate voice-enabled functions in some embodiments.

The I/O subsystem 635 involves the transfer between input/output peripheral devices, such as a display, a touch screen, etc., and the data bus of the processing units 605 through the peripherals interface 615. The I/O subsystem 635 includes a touch-screen controller 655 and other input controllers 660 to facilitate the transfer between input/output peripheral devices and the data bus of the processing units 605. As shown, the touch-screen controller 655 is coupled to a touch screen 665. The touch-screen controller 655 detects contact and movement on the touch screen 665 using any of multiple touch sensitivity technologies. The other input controllers 660 are coupled to other input/control devices, such as one or more buttons. Some embodiments include a near-touch sensitive screen and a corresponding controller that can detect near-touch interactions instead of or in addition to touch interactions.

The memory interface 610 is coupled to memory 670. In some embodiments, the memory 670 includes volatile memory (e.g., high-speed random access memory), non-volatile memory (e.g., flash memory), a combination of volatile and non-volatile memory, and/or any other type of memory. As illustrated in FIG. 6, the memory 670 stores an operating system (OS) 671. The OS 671 includes instructions for handling basic system services and for performing hardware dependent tasks.

The memory 670 also includes communication instructions 674 to facilitate communicating with one or more additional devices (e.g., for peer-to-peer data sharing, or to connect to a server through the Internet for cloud-based data sharing); graphical user interface instructions 676 to facilitate graphic user interface processing; image processing instructions 678 to facilitate image-related processing and functions; input processing instructions 680 to facilitate input-related (e.g., touch input) processes and functions; audio processing instructions 682 to facilitate audio-related processes and functions; and camera instructions 684 to facilitate camera-related processes and functions. The instructions described above are merely exemplary and the memory 670 includes additional and/or other instructions in some embodiments. For instance, the memory for a smartphone may include phone instructions to facilitate phone-related processes and functions. The above-identified instructions need not be implemented as separate software programs or modules. Various functions of the mobile computing device can be implemented in hardware and/or in software, including in one or more signal processing and/or application specific integrated circuits.

While the components illustrated in FIG. 6 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 6 may be split into two or more integrated circuits.

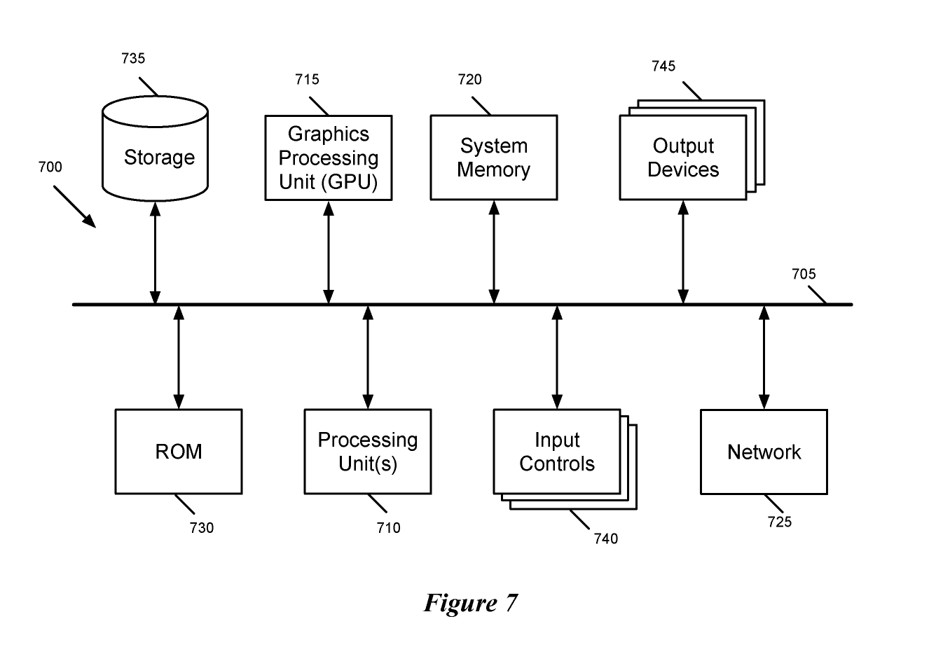

FIG. 7 conceptually illustrates another example of an electronic system 700 with which some embodiments of the invention are implemented. The electronic system 700 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 700 includes a bus 705, processing unit(s) 710, a graphics processing unit (GPU) 715, a system memory 720, a network 725, a read-only memory 730, a permanent storage device 735, input devices 740, and output devices 745.

The bus 705 collectively represents all system, peripheral, and chipset buses that communicatively connect the numerous internal devices of the electronic system 700. For instance, the bus 705 communicatively connects the processing unit(s) 710 with the read-only memory 730, the GPU 715, the system memory 720, and the permanent storage device 735.

From these various memory units, the processing unit(s) 710 retrieves instructions to execute and data to process in order to execute the processes of the invention. The processing unit(s) may be a single processor or a multi-core processor in different embodiments. Some instructions are passed to and executed by the GPU 715. The GPU 715 can offload various computations or complement the image processing provided by the processing unit(s) 710. In some embodiments, such functionality can be provided using CoreImage's kernel shading language.

The read-only-memory (ROM) 730 stores static data and instructions that are needed by the processing unit(s) 710 and other modules of the electronic system. The permanent storage device 735, on the other hand, is a read-and-write memory device. This device is a non-volatile memory unit that stores instructions and data even when the electronic system 700 is off. Some embodiments of the invention use a mass-storage device (such as a magnetic or optical disk and its corresponding disk drive, integrated flash memory) as the permanent storage device 735.

Other embodiments use a removable storage device (such as a floppy disk, flash memory device, etc., and its corresponding drive) as the permanent storage device. Like the permanent storage device 735, the system memory 720 is a read-and-write memory device. However, unlike storage device 735, the system memory 720 is a volatile read-and-write memory, such a random access memory. The system memory 720 stores some of the instructions and data that the processor needs at runtime. In some embodiments, the invention's processes are stored in the system memory 720, the permanent storage device 735, and/or the read-only memory 730. For example, the various memory units include instructions for processing multimedia clips in accordance with some embodiments. From these various memory units, the processing unit(s) 710 retrieves instructions to execute and data to process in order to execute the processes of some embodiments.

The bus 705 also connects to the input and output devices 740 and 745. The input devices 740 enable the user to communicate information and select commands to the electronic system. The input devices 740 include alphanumeric keyboards and pointing devices (also called “cursor control devices”), cameras (e.g., webcams), microphones or similar devices for receiving voice commands, etc. The output devices 745 display images generated by the electronic system or otherwise output data. The output devices 745 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 7, bus 705 also couples electronic system 700 to a network 725 through a network adapter (not shown). In this manner, the computer can be a part of a network of computers (such as a local area network (“LAN”), a wide area network (“WAN”), or an Intranet), or a network of networks, such as the Internet. Any or all components of electronic system 700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. For instance, a number of the figures (including FIGS. 3 and 5) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

We claim:

1. A method comprising:
from a third-party service, receiving a request for information regarding a particular device that is transacting with the third-party service, wherein the request comprises data encrypted by the particular device that is inaccessible to the third-party service;
accessing the encrypted data to determine a unique identifier of the particular device;
using the unique identifier to determine the requested information; and
providing the requested information to the third-party service without providing an identity of the device to the third-party service.

2. The method of claim 1, wherein the requested information comprises data regarding whether the device has previously performed a similar transaction with the third-party service.

3. The method of claim 2, wherein the transaction with the third-party service comprises signing up for an offer for new users only.

4. The method of claim 1, wherein the requested information comprises data regarding whether the device has previously been used for a fraudulent transaction with the third-party service.

5. The method of claim 1, wherein providing the requested information comprises providing two bits of data that provide two pieces of information about the device.

6. The method of claim 5, wherein the two bits of data each include an inexact timestamp.

7. The method of claim 6, wherein the inexact timestamp specifies a month and year.

8. The method of claim 1, wherein the provided information is information previously stored by the third-party service, wherein the third-party service is not provided any data that enables the third-party service to match the previously-stored information to the provided information.

9. The method of claim 1, wherein the encrypted data comprises a certificate identifying the particular device.

10. The method of claim 9, wherein the method is performed by a first set of servers of a manufacturer of the particular device, wherein the device transacts with a second set of servers of the device to acquire the certificate.

11. The method of claim 10, wherein the device uses a key generated from manufacturer-installed secure data to acquire the certificate from the second set of servers.

12. The method of claim 9, wherein the certificate identifying the particular device includes the unique identifier used to determine the requested information.

13. A non-transitory machine readable medium storing a program which when executed by at least one processing unit, the program comprising sets of instructions for:
receiving, from a third-party service, a request for information regarding a particular device that is transacting with the third-party service, wherein the request comprises data encrypted by the particular device that is inaccessible to the third-party service;
accessing the encrypted data to determine a unique identifier of the particular device;
using the unique identifier to determine the requested information; and
providing the requested information to the third-party service without providing an identity of the device to the third-party service.

14. The non-transitory machine readable medium of claim 13, wherein the data is encrypted with a key generated by the particular device based on (i) a private key of a randomly-generated single-transaction key pair and (ii) a public key of a key pair registered to a set of servers that perform the method.

15. The non-transitory machine readable medium of claim 14, wherein the set of instructions for accessing the encrypted data comprises a set of instructions for generating a key that corresponds to the key generated by the particular device based on (i) a public key of the randomly-generated single-transaction key pair and (ii) a private key of the key pair registered to the set of servers, wherein the public key of the randomly-generated single-transaction key pair is included unencrypted with the request.

16. The non-transitory machine readable medium of claim 13, wherein the request further comprises data from the third-party service identifying a developer of the third-party service.

17. The non-transitory machine readable medium of claim 16, wherein the data from the third-party service comprises a token, the program further comprising a set of instructions for validating the token and identifying a list of applications associated with the third-party service developer.

18. The non-transitory machine readable medium of claim 17, wherein the request further comprises an encrypted identifier of an application on the device that is transacting with the third-party service, the program further comprising a set of instructions for verifying that the application identifier matches one of the applications in the list of applications.

19. The non-transitory machine readable medium of claim 13, wherein the set of instructions for using the unique identifier to determine the requested information comprises a set of instructions for accessing a database that stores the requested information for each of a plurality of device identifiers, wherein the requested information is specific to an application operating on the device that transacts with the third-party service.

20. The non-transitory machine readable medium of claim 13, wherein the provided information is information previously stored by the third-party service, wherein the third-party service is not provided any data that enables the third-party service to match the previously-stored information to the provided information.
